(19) United States
(12) Patent Application Publication
(10) Pub. No.: US 2018/0324344 A1
(43) Pub. Date: Nov. 8, 2018

(54) IMAGE PROCESSOR, IMAGE PROCESSING METHOD, AND PROGRAM

(71) Applicant: SONY CORPORATION, TOKYO (JP)

(72) Inventor: MASAYA KINOSHITA, KANAGAWA (JP)

(21) Appl. No.: 15/773,664

(22) PCT Filed: Sep. 8, 2016
(86) PCT No.: PCT/JP2016/076431

§ 371 Date: May 4, 2018

(30) Foreign Application Priority Data
Nov. 24, 2015 (JP) 2015-228789

(51) Int. Cl. H04N 5/235

(52) U.S. Cl. CPC H04N 5/2357; H04N 7/0132; H04N 5/2355

(57) ABSTRACT

An image processor of the disclosure includes a detector that detects a flicker component in first image data on the basis of a plurality of pieces of first image data in a stream. The stream includes, at least, the plurality of pieces of first image data having first exposure time and a plurality of pieces of second image data having second exposure time. The stream is provided with a temporally-alternate arrangement of the first image data and the second image data. The second exposure time is different from the first exposure time.

### TECHNICAL FIELD

The disclosure relates to an image processor related to a process of a flicker component included in a plurality of pieces of image data, to an image processing method, and to a program.

### BACKGROUND ART

A technique that reduces a flicker component included in a captured image has been known, for example, as disclosed in PTL 1. Meanwhile, regarding a recent digital camera, a camera mounted on a recent mobile phone, etc., rapid progress has been made in an increase in resolution and an increase in frame rate, in order to improve image quality. Moreover, as a next great trend in further improvement in image quality, progress has been made in high dynamic range (HDR) having an increased dynamic range of luminance. The HDR technique has been already used commercially in a monitoring application. PTL 2 discloses a technique that generates an HDR image. A general basic method of generating an HDR image is a method that performs synthesis of a group of two images or three or more images that have different exposure times to once generate an image having a high dynamic range in an intermediate process, and thereafter, performs re-quantization (slim-down of luminance) by the use of a tone curve designed to match the quantization bit rate of various recording formats. Upon generation of such an HDR image, it is desired to reduce a flicker component of each image on the basis of which the HDR image is generated. PTL 3 discloses a technique that reduces a flicker component of each of a plurality of groups of images that are different in exposure time, independently of other group of images.

### CITATION LIST

### Patent Literature

[PTL 1] Japanese Patent No. 4423889

[PTL 2] Japanese Patent No. 5574792

[PTL 3] Japanese Unexamined Patent Application Publication No. 2004-112403

### SUMMARY OF THE INVENTION

Incidentally, a CCD (Charge Coupled Device) has been generally used before as an imaging device used in an imaging apparatus. In recent years, however, a rise of a CMOS (Complementary Metal Oxide Semiconductor) sensor has been remarkable in terms of cost, electric power, function, image quality, etc. Therefore, the COMS sensor has been the mainstream in both consumer apparatus and industrial apparatus.

PTL 3 described above discloses a technique that: allocates, to different circuits independent of each other, frame images that are different in exposure condition necessary for synthesis of HDR images; exclude an influence of flicker by smoothing each image having flicker in a time direction; and thereafter performs an HDR synthesis process. The technique disclosed in PTL 3 described above, however, has a configuration that is specialized for CCD and does not avoid a flicker phenomenon unique to a COMS sensor. Moreover, in the technique disclosed in PTL 3 described above, it may be necessary to perform a process of detecting a flicker component and a correction process, separately for respective image groups that are different in exposure time. Therefore, an increase in number of image groups having different exposure times that are required by an HDR algorithm may necessitate a similar increase in number of a flicker component detection circuit and of a correction circuit. For example, two systems may be necessary in order to perform synthesis of two images. For example, three systems may be necessary in order to perform synthesis of three images. Therefore, the technique disclosed in PTL 3 described above may lead to a system configuration that lacks expandability in terms of circuit size, electric power, and cost. For example, in a case where an imaging apparatus has a configuration that is able to make a selection between a regular shooting mode and a HDR-image shooting mode, the number of circuits or processes that are not used and therefore completely useless in the regular shooting mode is increased.

It is desirable to provide an image processor, an image processing method, and a program that each achieve easy detection of a flicker component included in a plurality of pieces of image data that are different from each other in exposure time.

### Means for Solving Problem

An image processor according to one embodiment of the disclosure includes a detector that detects a flicker component in first image data on the basis of a plurality of pieces of first image data in a stream. The stream includes, at least, the plurality of pieces of first image data having first exposure time and a plurality of pieces of second image data having second exposure time. The stream is provided with a temporally-alternate arrangement of the first image data and the second image data. The second exposure time is different from the first exposure time.

An image processing method according to one embodiment of the disclosure includes detecting a flicker component in first image data on the basis of a plurality of pieces of first image data in a stream. The stream includes, at least, the plurality of pieces of first image data having first exposure time and a plurality of pieces of second image data having second exposure time. The stream is provided with a temporally-alternate arrangement of the first image data and the second image data. The second exposure time is different from the first exposure time.

A program according to one embodiment of the disclosure a program that causes a computer to function as a detector that detects a flicker component in first image data on the basis of a plurality of pieces of first image data in a stream. The stream includes, at least, the plurality of pieces of first image data having first exposure time and a plurality of pieces of second image data having second exposure time. The stream is provided with a temporally-alternate arrangement of the first image data and the second image data. The second exposure time is different from the first exposure time.

In the image processor, the image processing method, or the program according to one embodiment of the disclosure, the flicker component in the first image data is detected on the basis of the plurality of pieces of the first image data in the stream including the plurality of pieces of image data that are different from each other in exposure time.

According to the image processor, the image processing method, or the program of one embodiment of the disclosure, the flicker component in the first image data is detected on the basis of the plurality of pieces of the first image data in the stream including the plurality of pieces of image data that are different from each other in exposure time. Therefore, it is possible to easily detect a flicker component included in a plurality of pieces of image data that are different from each other in exposure time.

It is to be noted that the effects described here are not necessarily limiting, and any of effects described in the disclosure may be provided.

### BRIEF DESCRIPTION OF DRAWINGS

FIG. 1 is a configuration diagram illustrating a basic configuration example of an image processor according to a first embodiment of the disclosure.

FIG. 2 is a configuration diagram illustrating a first example of an imaging apparatus, according to the first embodiment, that includes the image processor illustrated in FIG. 1.

FIG. 3 is a configuration diagram illustrating a second example of the imaging apparatus, according to the first embodiment, that includes the image processor illustrated in FIG. 1.

FIG. 4 is an explanatory diagram illustrating one example of a plurality of pieces of image data that are different in exposure time.

FIG. 5 is an explanatory diagram illustrating a first example of a method of generating an HDR synthesized image.

FIG. 6 is an explanatory diagram illustrating a second example of the method of generating the HDR synthesized image.

FIG. 7 is a configuration diagram illustrating one example of the imaging apparatus according to the first embodiment of the disclosure.

FIG. 8 is a configuration diagram illustrating one example of a flicker-detection and correction unit of the imaging apparatus illustrated in FIG. 7.

FIG. 9 is an explanatory diagram illustrating one example of a method of calculating an amplitude ratio of flicker component of long-time exposure from an amplitude ratio of flicker component of short-time exposure.

FIG. 10 is an explanatory diagram illustrating a data example of a reference table used in estimation of a flicker component.

FIG. 11 is an explanatory diagram illustrating one example of a method of calculating a phase of a flicker component.

FIG. 12 is a configuration diagram illustrating one example of a flicker-detection and correction unit according to a second embodiment.

FIG. 13 is an explanatory diagram illustrating one example of flicker that occurs in a case where an imaging device is a CCD.

FIG. 14 is an explanatory diagram illustrating one example of flicker that occurs in a case where the imaging device is a CMOS sensor.

FIG. 15 is an explanatory diagram illustrating one example of a stripe pattern in one screen that is caused by flicker, in a case where the imaging device is the CMOS sensor.

FIG. 16 is an explanatory diagram illustrating one example of a stripe pattern in three successive screens that is caused by flicker, in the case where the imaging device is the CMOS sensor.

FIG. 17 is an explanatory diagram illustrating one example of variation in magnitude of flicker component that is caused by a difference in exposure time.

FIG. 18 is an explanatory diagram illustrating one example of a period of a flicker component in a case where the exposure time is 1/60 sec.

FIG. 19 is an explanatory diagram illustrating one example of a period of a flicker component in a case where the exposure time is 1/1000 sec.

FIG. 20 is an explanatory diagram illustrating another example of the plurality of pieces of image data that are different in exposure time.

### DESCRIPTION OF EMBODIMENTS

Embodiments of the disclosure are described below in detail with reference to the drawings. It is to be noted that the description is given in the following order.

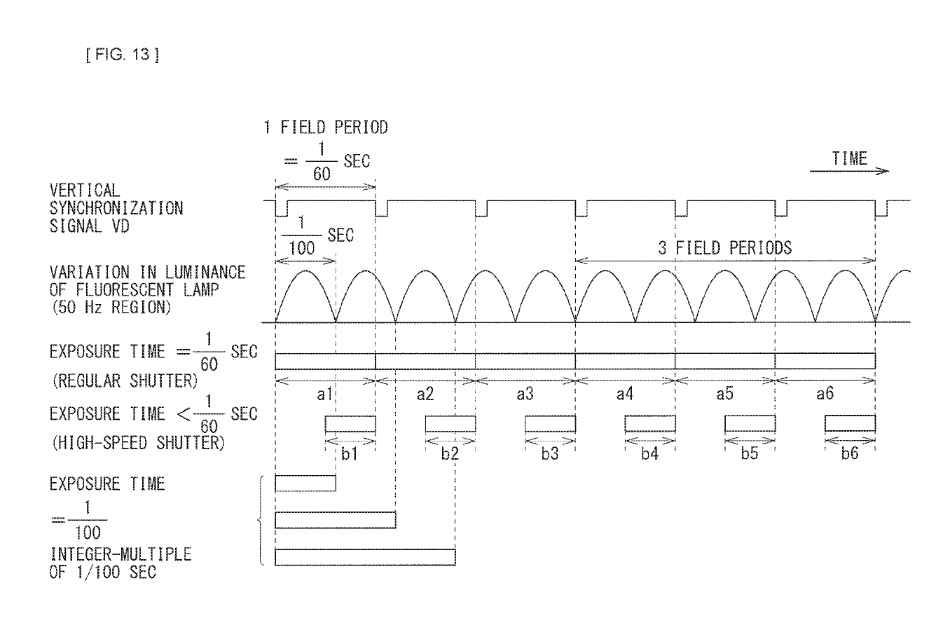

0. Overview of Flicker (FIGS. 13 to 19)

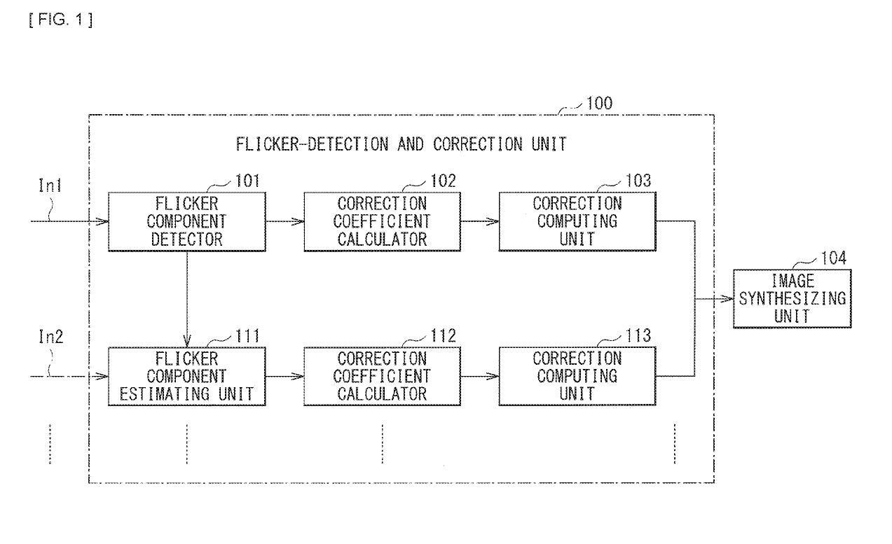

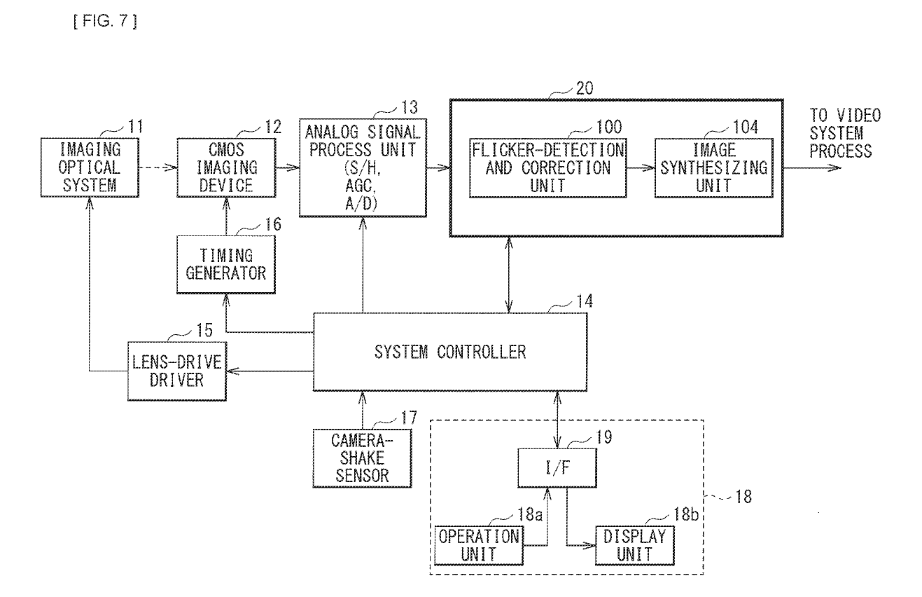

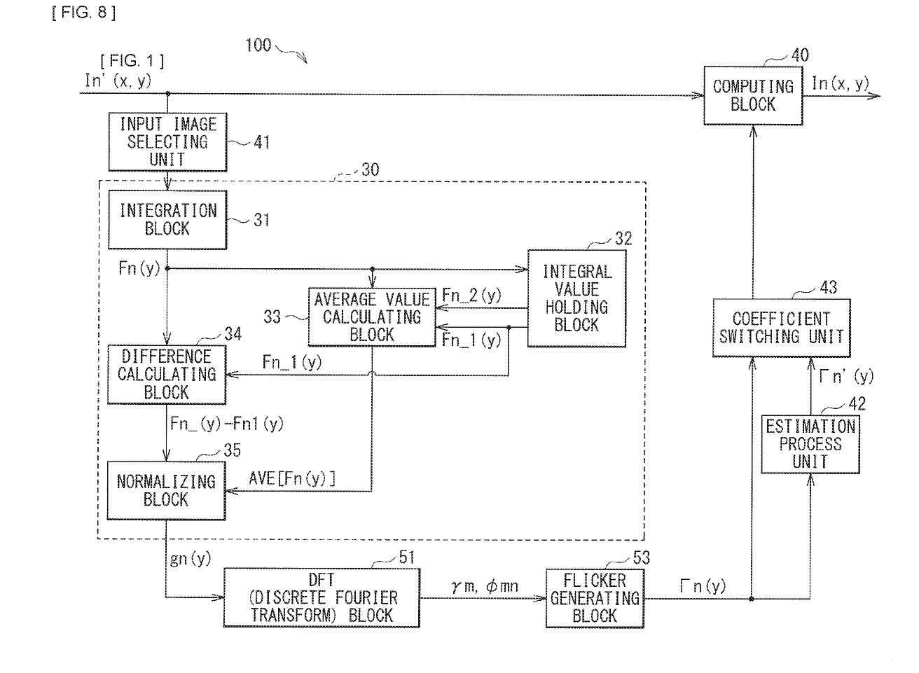

1. First Embodiment
1.1 Overview of Image Processor and Imaging Apparatus (FIGS. 1 to 6)
1.2 Specific Configuration and Specific Operation of Imaging Apparatus (FIGS. 7 to 11)
1.3 Effects

2. Second Embodiment (An apparatus that determines whether or not to perform a correction process that reduces flicker)

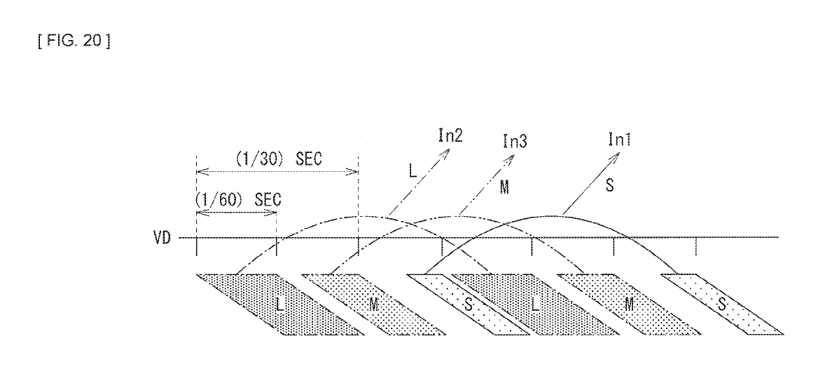

3. Other Embodiments (FIG. 20)

### 0. Overview of Flicker

First, a description is given of an overview of flicker that is a target of a process performed by an image processor according to the present embodiment, before explaining the image processor and an imaging apparatus according to the present embodiment.

FIG. 13 illustrates one example of flicker that occurs in a case where an imaging device is a CCD. When an object is shot by a video camera under illumination of a fluorescent lamp that is directly turned on by a commercial alternate-current power supply, an image signal of shooting output involves temporal variation in brightness, i.e., so-called fluorescent-lamp flicker. Such fluorescent-lamp flicker may be caused by a difference between a frequency of luminance variation (variation in quantity of light) of the fluorescent lamp and a vertical synchronization frequency of the camera.

For example, in a case where an object is shot by a CCD camera of an NTSC system having a vertical synchronization frequency of 60 Hz under illumination of a non-inverter fluorescent lamp in a region having a commercial alternate-current power supply of 50 Hz, one field period is 1/60 sec, meanwhile a period of luminance variation of the fluorescent lamp is 1/100 sec, as illustrated in FIG. 13. Accordingly, exposure timing of each filed is shifted relative to the luminance variation of the fluorescent lamp, which causes variation in exposure amount of each pixel between respective fields.

Therefore, for example, when the exposure time is 1/60 sec, the exposure amounts are different despite of the same exposure time as in time periods a1, a2, and a3, as illustrated in FIG. 13. Further, when the exposure is shorter than 1/60 sec (but not 1/100 sec), the exposure amounts are different despite of the same exposure time as in time periods b1, b2, and b3.

The exposure timing relative to the luminance variation of the fluorescent lamp returns to the initial timing by each three fields. Therefore, variation in brightness caused by the flicker is repeated by each three fields. In other words, a luminance ratio (how the flicker appears) of each field is varied depending on the exposure time period, however, the period of the flicker is not varied.

However, in a case of the progressive camera such as a digital camera having a vertical synchronization frequency of 30 Hz, the variation in brightness is repeated by each three frames.

In contrast, the exposure amount is constant independently of the exposure timing, and therefore no flicker occurs, when the exposure time is set to an integer-multiple of the period ( 1/100 sec) of the luminance variation of the fluorescent lamp as illustrated in a lowest part of FIG. 13.

In fact, a method has been considered that sets the exposure time to an integer-multiple of 1/100 sec in a case of shooting under the illumination of the fluorescent lamp by detecting the fact that the shooting is performed under the illumination of the fluorescent lamp. The detection of the fact that shooting is performed under the illumination of the fluorescent lamp is performed through an operation performed by a user or a signal process performed by the camera. This method makes it possible to completely prevent occurrence of the flicker by a simple method.

However, it is not possible to set the exposure time to any exposure time in this method. This decreases flexibility in exposure amount adjusting unit directed to achievement of appropriate exposure.

Therefore, a method that is able to reduce the fluorescent-lamp flicker with any shutter speed (any exposure time) is required.

This can be achieved relatively easily in a case of an imaging apparatus, such as a CCD imaging apparatus, in which all the pixels in one screen are subjected to exposure at the same exposure timing. A reason for this is that the variation in brightness and in color caused by the flicker appears only between fields.

For example, in the case illustrated in FIG. 13, the flicker occurs by a repetition period of three fields when the exposure time is not the integer-multiple of 1/100 sec. Therefore, it is possible to suppress the flicker to a level that causes no practical problem, by so estimating current variation in luminance and in color from an image signal three fields before that an average value of the image signals in the respective fields becomes constant, and adjusting a gain of the image signal of each filed in accordance with a result of the estimation.

It is, however, not possible to sufficiently suppress the flicker by the method described above in a case of an imaging device of an XY-address scanning type such as the CMOS sensor. A reason for this is that the exposure timing of each pixel is sequentially shifted by one period of a reading clock (a pixel clock) in a horizontal direction of the screen, and therefore, the exposure timing is different between all of the pixels.

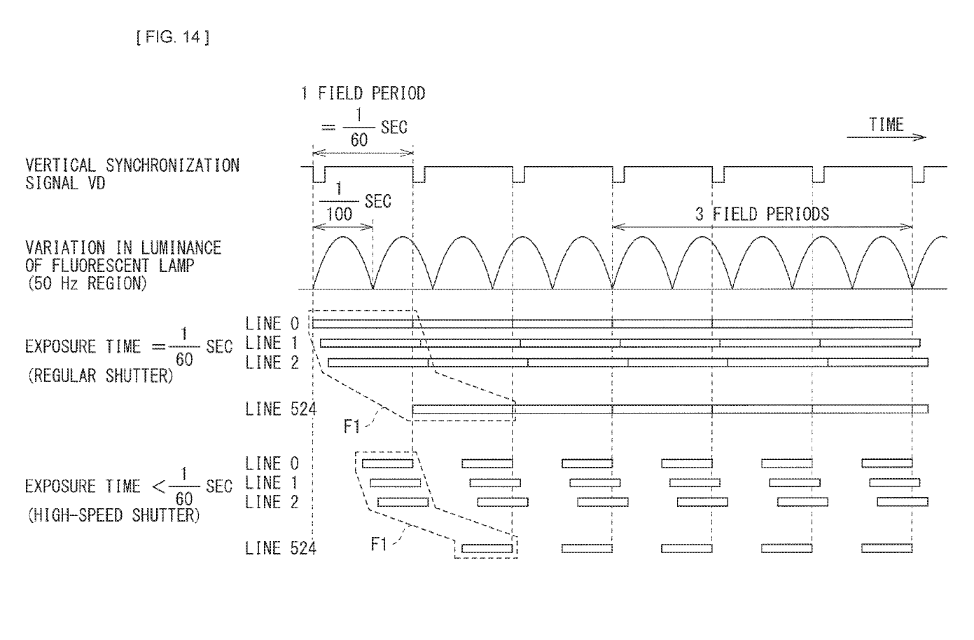

FIG. 14 illustrates one example of flicker that occurs in a case where the imaging device is the CMOS sensor. The exposure timing of each pixel is sequentially shifted also in the horizontal direction of the screen as described above. However, one horizontal period is sufficiently short compared with a period of the luminance variation of the fluorescent lamp. Therefore, exposure timing of each line in a vertical direction of the screen is illustrated on the assumption that the pixels on the same line have the same exposure timing. In fact, such an assumption causes no problem.

As illustrated in FIG. 14, the exposure timing is different between lines in the CMOS sensor. In FIG. 14, “F1” indicates the exposure timing in one certain field. In one field, the exposure amount is different between lines. Therefore, the variation in brightness and the variation in color due to the flicker are caused not only between fields but also in one field. This appears as a stripe pattern on the screen. In this case, a direction of the stripes themselves is the horizontal direction, and a direction in which the stripes are varied is the vertical direction.

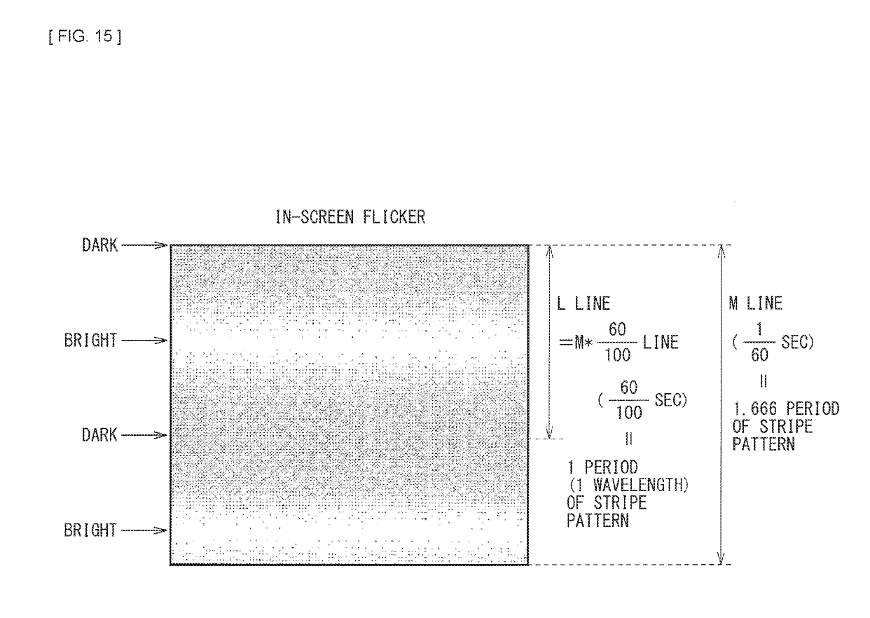

FIG. 15 illustrates one example of the stripe pattern in one screen caused by the flicker in the case where the imaging device is the CMOS sensor. FIG. 15 illustrates a state of the flicker in the screen in a case where the object is a uniform pattern. On the basis of the fact that one period (one wavelength) of the stripe pattern is 1/100 sec, the stripe pattern of 1.666 period is present in one screen. When the number of reading lines per one field is “M”, one period of the stripe pattern corresponds to L=M*60/100 in the number of reading lines. It is to be noted that an asterisk (*) is used as a symbol for multiplication in the present description and the drawings.

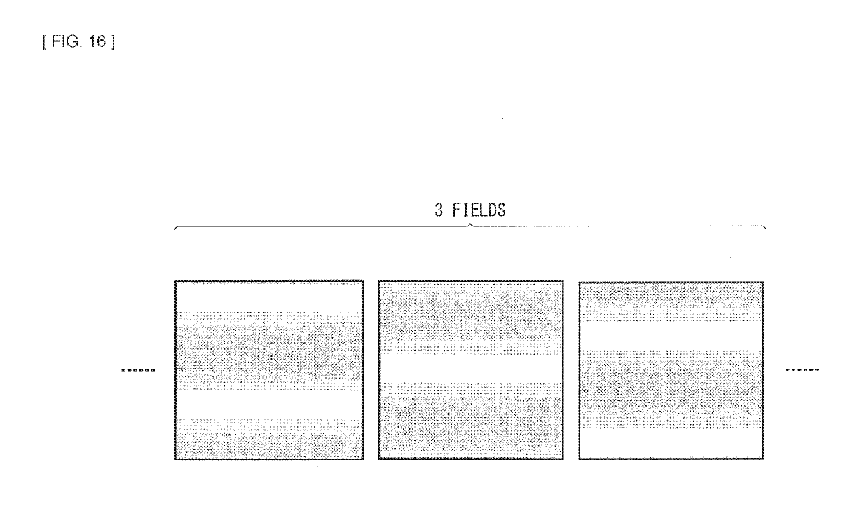

FIG. 16 illustrates one example of a stripe pattern in three successive screens caused by the flicker in the case where the imaging device is the CMOS sensor. As illustrated in FIG. 16, the stripe pattern for three fields (three screens) corresponds to five periods (five wavelengths). Such a stripe pattern is viewed as if the stripe pattern moves in the vertical direction when viewed successively.

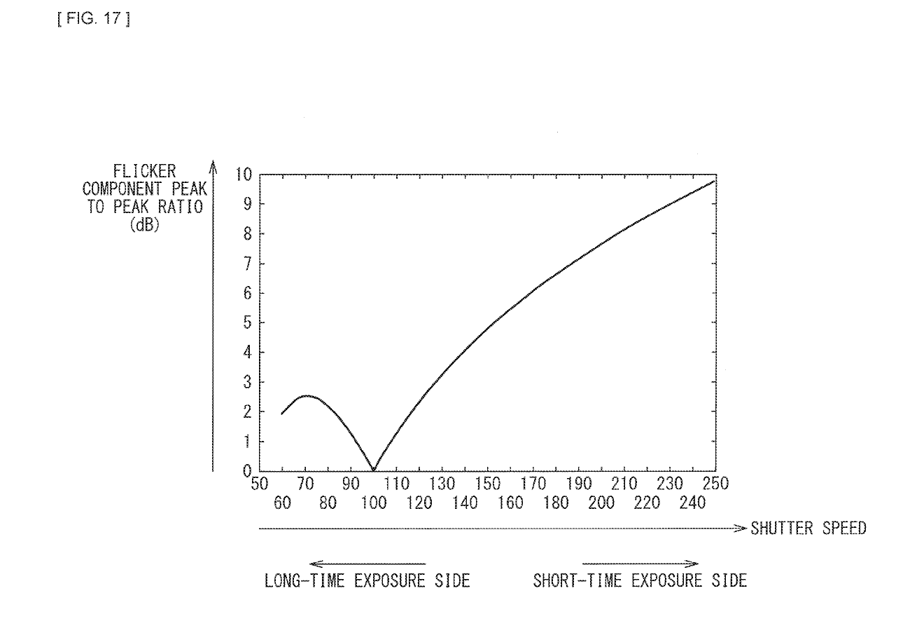

FIG. 17 illustrates one example of variation in magnitude of the flicker component caused by a difference in exposure time, in the case where the imaging device is the CMOS sensor. In FIG. 17, the horizontal axis indicates a shutter speed (a reciprocal of the exposure time), and the vertical axis indicates an amplitude ratio of flicker component. FIG. 17 illustrates a case of the NTSC system in which the commercial alternate-current power supply frequency is 50 Hz and the vertical synchronization frequency is 60 Hz.

As illustrated in FIG. 17, the variation in amplitude ratio of flicker component is increased as the shutter speed is increased (as the exposure time is decreased).

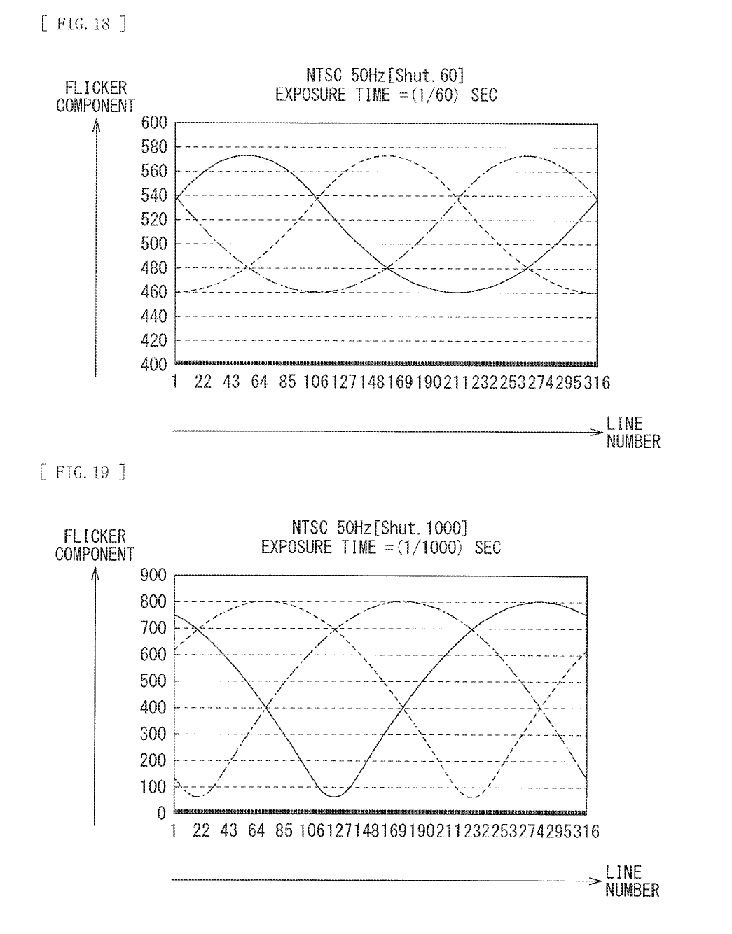

FIG. 18 illustrates one example of the period of the flicker component in a case where the imaging device is the CMOS sensor and the exposure time is 1/60 sec. FIG. 19 illustrates one example of the period of the flicker component in a case where the imaging device is the CMOS sensor and the exposure time is 1/1000 sec. In both FIGS. 18 and 19, the horizontal axis indicates the line number, and the vertical axis indicates an amplitude of the flicker component. FIGS. 18 and 19 both illustrate a waveform of the flicker component for each field in the three successive fields.

As illustrated in FIGS. 18 and 19, the waveform of the flicker component is deviated more from a sine wave as the shutter speed is increased (as the exposure time is decreased).

### 1. First Embodiment

### [1.1 Overview of Image Processor and Imaging Apparatus]

FIG. 1 is a configuration diagram illustrating a basic configuration example of an image processor according to a first embodiment of the disclosure.

The image processor according to the present embodiment includes a flicker-detection and correction unit 100. The flicker-detection and correction unit 100 includes a flicker component detector 101, a correction coefficient calculator 102, a correction computing unit 103, an image synthesizing unit 104, a flicker component estimating unit 111, a correction coefficient calculator 112, and a correction computing unit 113.

It is to be noted that, although FIG. 1 illustrates a configuration example of circuits that perform processes on respective two image data groups, i.e., a first image data group In1 and a second image data group In2, circuits that perform processes on a third image data group, a fourth image data group, and so on may be further provided. In this case, a circuit substantially similar to the circuit that performs a process on the second image data group In2 may be provided. Alternatively, the circuit that performs a process on the second image data group In2 may also have the function of the circuit that performs a process on the third image data group, the fourth image data group, and so on. This makes it possible to increase the number of the image data group to be subjected to a process while suppressing the circuit size.

Each of the first image data group In1 and the second image data group In2 includes a plurality of pieces of image data. The first image data group In1 includes a plurality of pieces of first image data having first exposure time. The second image data group In2 includes a plurality of pieces of second image data having second exposure time that is different from the first exposure time. The first exposure time is preferably shorter than the second exposure time. For example, the first image data group In1 includes a plurality of pieces of data of short-time exposure images S, and the second image data group In2 includes a plurality of pieces of data of long-time exposure images L, as will described later. Also in a case where the number of image data group is increased as the third image data group, the fourth image data group, and so on, the image data having the flicker component to be detected by the flicker component detector 101 described later is preferably image data having the shortest exposure time in the plurality of pieces of image data.

The flicker component detector 101 is a detector that detects a flicker component in the first image data group In1 on the basis of the first image data group In1.

The flicker component estimating unit 111 is an estimating unit that estimates a flicker component in the second image data group In2 on the basis of a result of the detection performed by the flicker component detector 101.

The flicker component estimating unit 111 estimates an amplitude of the flicker component in the second image data group In2 on the basis of a difference in exposure time between the first image data group In1 and the second image data group In2, as will described later.

Further, the flicker component estimating unit 111 estimates an initial phase of the flicker component in the second image data group In2 on the basis of a difference in exposure start timing between the first image data group In1 and the second image data group In2, as will described later.

The correction coefficient calculator 102 calculates, on the basis of the result of the detection performed by the flicker component detector 101, a correction coefficient (a flicker coefficient Γn(y) which will be described later) directed to reduction of the flicker component for the image data of the first image data group In1.

The correction computing unit 103 is a first computing unit that performs a process, on the image data of the first image data group In1, that reduces the flicker component, on the basis of the result of the detection performed by the flicker component detector 101 and a result of the coefficient calculation process performed by the correction coefficient calculator 102.

The correction coefficient calculator 112 calculates, on the basis of a result of the estimation performed by the flicker component estimating unit 1111, a correction coefficient (a flicker coefficient Γn′(y) which will be described later) directed to reduction of the flicker component for image data of the second image data group In2.

The correction computing unit 113 is a second computing unit that performs, on the image data of the second image data group In2, a process that reduces the flicker component, on the basis of the result of the estimation performed by the flicker component estimating unit 111 and a result of the coefficient calculation process performed by the correction coefficient calculator 112.

It is to be noted that it is possible to configure the correction computing unit 103 and the correction computing unit 113 as a single block, as a computing block 40 in a configuration example illustrated in FIG. 8 which will be described later. This makes it possible to simplify the circuit configuration.

The image synthesizing unit 104 is an image synthesizing unit that performs synthesis of the image data of the first image data group In1 after the process that reduces the flicker component is performed by the correction computing unit 103 and the image data of the second image data group In2 after the process that reduces the flicker component is performed by the correction computing unit 113. The image synthesizing unit 104 performs, for example, a process that generates an HDR synthesized image having an increased dynamic range.

### [Examples of Application to Imaging Apparatus]

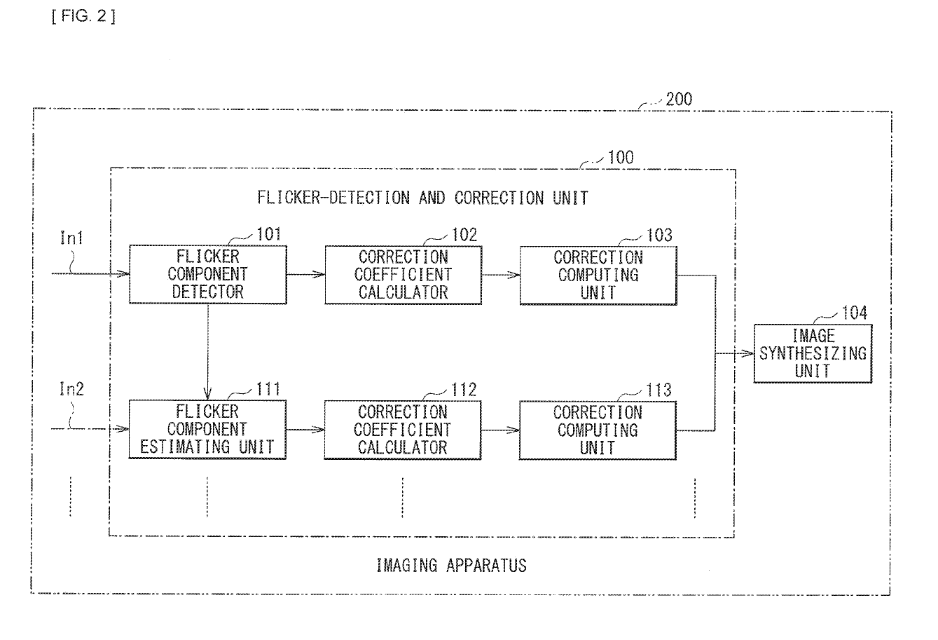

FIG. 2 illustrates a first example of an imaging apparatus including the image processor illustrated in FIG. 1. The entire image processor illustrated in FIG. 1 may be included in a single imaging apparatus 200, as in the configuration example illustrated in FIG. 2. In this case, the first image data configuring the first image data group In1 and the second image data configuring the second image data group In2 may be inputted to the image processor as a stream in which the first image data configuring the first image data group In1 and the second image data configuring the second image data group In2 are provided in a temporally-alternate arrangement. Here, the stream is an image data stream including a plurality of successive fields or a plurality of successive frames.

Further, the technology of the disclosure is also applicable to a multi-camera system that includes a plurality of imaging apparatuses that are synchronized with each other. In that case, one imaging apparatus may be the main imaging apparatus and may be directed to flicker-component detection; and other imaging apparatuses may estimate the flicker component on the basis of a result of the detection of the flicker component performed by the main imaging apparatus. The correction process that reduces flicker may be performed by each of the imaging apparatuses. The imaging apparatuses may be so coupled to each other by wire or wirelessly that the imaging apparatuses are able to perform transmission of necessary data with each other. The image synthesizing unit 104 may be included in the main imaging apparatus. Alternately, an apparatus directed to image synthesis may be provided separately.

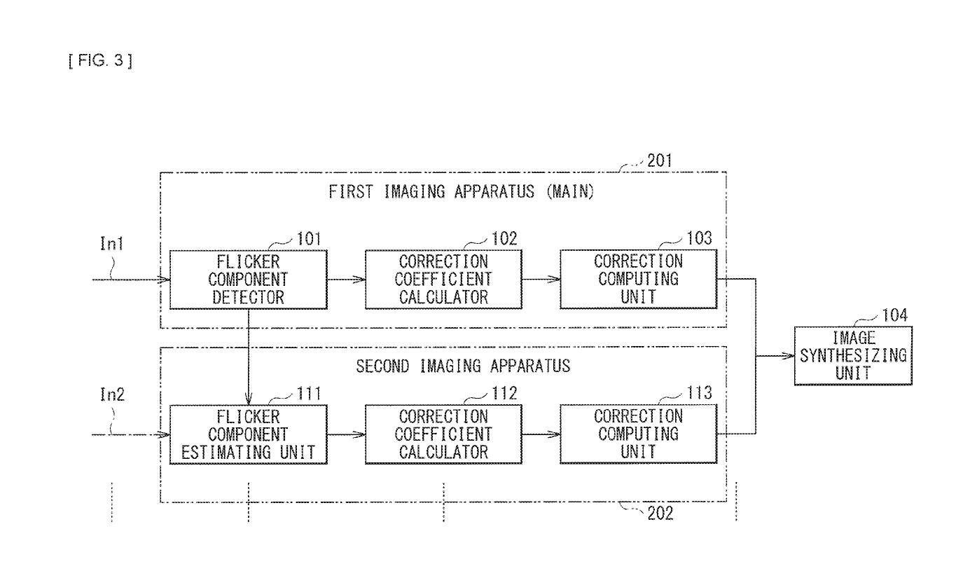

FIG. 3 illustrates a second example of the imaging apparatus including the image processor illustrated in FIG. 1. As illustrated in FIG. 3, a first imaging apparatus 201 and a second imaging apparatus 202 may be provided separately to include the image processor illustrated in FIG. 1. For example, the first imaging apparatus 201 may be the main imaging apparatus. The flicker component detector 101, the correction coefficient calculator 102, and the correction computing unit 103 may be included in the first imaging apparatus 201. Further, the flicker component estimating unit 111, the correction coefficient calculator 112, and the correction computing unit 113 may be included in the second imaging apparatus 202. In this case, the stream of the first image data group In1 is allowed to be subjected to a signal process in the first imaging apparatus 201, and the stream of the second image data group In2 is allowed to be subjected to a signal process in the second imaging apparatus 202.

It is to be noted that the process of each unit of the image processor illustrated in FIG. 1 is executable as a program by a computer. A program of the disclosure is, for example, a program that is provided, for example, in a storage medium, to an information processor, a computer system, etc. that are able to execute various program codes. A process in accordance with the program is achieved by causing a program executing unit of the image processor, the computer system, etc. to execute such a program.

Moreover, a series of processes described in the description are executable by hardware, software, or a composite configuration including both the hardware and the software. In a case where the process is executed by the software, the process is executable by installing a program storing a process sequence on a memory in a computer built in dedicated hardware, or by installing the program on a general-purpose computer that is able to execute various processes. For example, it is possible to store the program in a storage medium in advance. It is possible to install the program on the computer from the storage medium. Alternatively, it is possible to receive the program via a network such as a LAN (Local Area Network) or the Internet, and install the received program on a storage medium such as a built-in hard disk.

### [Examples of First and Second Image Data Groups]

FIG. 4 illustrates one example of a plurality of types of image data that are different in exposure time. FIG. 4 illustrates an example in which the vertical synchronization frequency is 60 Hz, and one field period is 1/60 sec. In this case, a plurality of pieces of first image data configuring the first image data group In1 and a plurality of pieces of second image data configuring the second image data group In2 may be inputted to the image processor as a stream in which the plurality of pieces of first image data configuring the first image data group In1 and the plurality of pieces of second image data configuring the second image data group In2 are provided in a temporally-alternate arrangement.

FIG. 4 illustrates an example in which imaging of the long-time exposure image L and imaging of the short-time exposure image S are performed alternately. The long-time exposure image L has exposure time that is 1/60 sec at the longest. The short-time exposure image S has exposure time that is shorter than that of the long-time exposure image L. In other words, a stream is achieved that includes a plurality of pieces of data of short-time exposure images S and a plurality of pieces of data of long-time exposure images L and is provided with a temporally-alternate arrangement of the data of the short-time exposure image S and the data of the long-time exposure image L. In this case, one period or more of flicker component are included in a total imaging time period of one long-time exposure image L and one short-time exposure image S. Further, exposure start timing of the long-time exposure image L is the same in the respective fields. Further, exposure start timing of the short-time exposure image S is the same in the respective fields.

Here, it is possible to detect the flicker component by the flicker component detector 101 also when any of the image data group of the long-time exposure image L and the image data group of the short-time exposure image S is used as the first image data group In1 by the flicker-detection and correction unit 100 illustrated in FIG. 1. However, as illustrated in FIGS. 17 to 19, variation in amplitude ratio of flicker component is increased as the shutter speed is increased (as the exposure time is decreased). Further, the waveform of the flicker component is deviated more from the sine wave as the shutter speed is increased (as the exposure time is decreased). It is therefore preferable to accurately detect the flicker component of the image data group having the shorter exposure time. For this reason, it is preferable to use, in the detection, the image data group of the short-time exposure image S as the first image data group In1.

### [Example of HDR Synthesized Image]

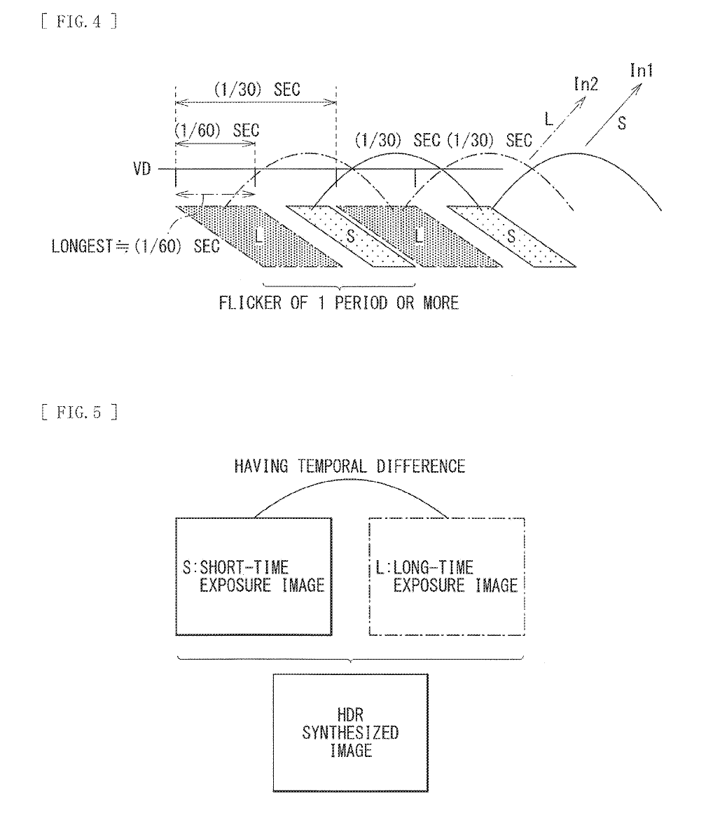

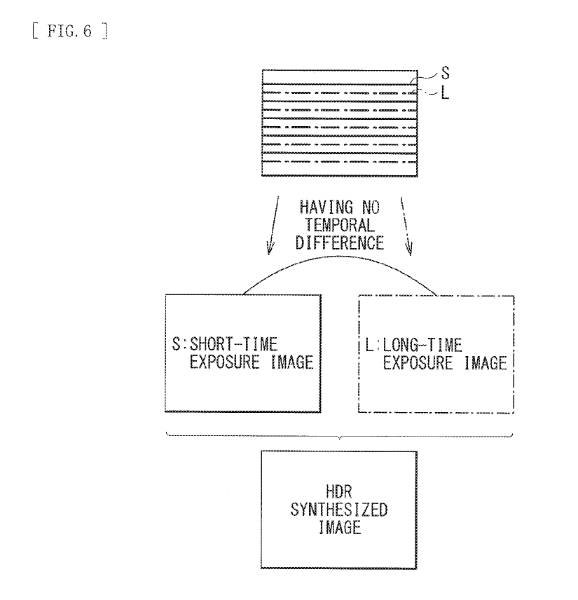

FIG. 5 illustrates a first example of a method of generating an HDR synthesized image. FIG. 6 illustrates a second example of the method of generating the HDR synthesized image.

Generation of the HDR synthesized image is generated by performing synthesis of a plurality of pieces of image data that are different in exposure time, for example, as illustrated in FIG. 5. For example, the generation of the HDR synthesized image is generated by performing synthesis of the data of the short-time exposure image S and the data of the long-time exposure image L. In this case, it is possible to perform imaging of the short-time exposure image S and the long-time exposure image L by varying the exposure time in temporally-different fields, as illustrated in FIG. 4.

Meanwhile, as illustrated in FIG. 6, it is also possible to perform imaging of the short-time exposure image S and the long-time exposure image L by varying the exposure time for each line in a single field. In this case, the data of the short-time exposure image S and the data of the long-time exposure image L may also be possibly inputted to the image processor of the disclosure as a stream in which the data of the short-time exposure image S and the data of the long-time exposure image L are provided in a temporally-alternate arrangement, as in the example illustrated in FIG. 4. Alternatively, the data of the short-time exposure image S and the data of the long-time exposure image L may be possibly inputted to the image processor in parallel as separate streams. The technology of the disclosure is also applicable to a plurality of pieces of image data that are different in exposure time and obtained in the same field or in the same frame.

### [1.2 Specific Configuration and Specific Operation of Imaging Apparatus]

FIG. 7 illustrates a specific configuration example of an imaging apparatus according to the first embodiment of the disclosure.

It is to be noted that FIG. 7 illustrates a configuration example of a video camera that uses a CMOS sensor of an XY-address scanning type as the imaging device. The technology of the disclosure is, however, also applicable to a case in which a CCD is used as the imaging device.

This imaging apparatus includes an imaging optical system 11, a CMOS imaging device 12, an analog signal process unit 13, a system controller 14, a lens-drive driver 15, a timing generator 16, a camera-shake sensor 17, a user interface 18, and a digital signal process unit 20.

The digital signal process unit 20 corresponds to the image processor illustrated in FIG. 1. The flicker-detection and correction unit 100 and the image synthesizing unit 104 both illustrated in FIG. 1 are included in the digital signal process unit 20.

In this imaging apparatus, light from an object enters the CMOS imaging device 12 via the imaging optical system 11, and is subjected to photoelectric conversion by the CMOS imaging device 12. An analog image signal is thereby obtained from the CMOS imaging device 12.

The CMOS imaging device 12 includes a plurality of imaging pixels that are two-dimensionally arranged on a CMOS substrate. Further, the CMOS imaging device 12 includes a vertical scanning circuit, a horizontal scanning circuit, and an image signal output circuit.

The CMOS imaging device 12 may be any of a primary color type and a complementary color type, and the analog image signal obtained from the CMOS imaging device 12 is a primary color signal of any of R, G, and B, or a complementary color signal.

Each color signal of the analog image signal from the CMOS imaging device 12 is subjected to sample and hold (S/H), a gain control through AGC (automatic gain control), and conversion to a digital signal through A/D conversion, in the analog signal process unit 13 configured as an IC (integrated circuit).

The digital image signal from the analog signal process unit 13 is subjected to the flicker-detection and correction process by the flicker-detection and correction unit 100, the image synthesis process by the image synthesizing unit 104, etc. in the digital signal process unit 20 configured as an IC. The digital image signal outputted from the digital signal process unit 20 is subjected to a moving image process in an unillustrated video system process circuit.

The system controller 14 includes a microcomputer, etc., and controls each unit of a camera. For example, a lens drive control signal is supplied from the system controller 14 to the lens-drive driver 15, and a lens of the imaging optical system 11 is thereby driven by the lens-drive driver 15. The lens-drive driver 15 includes an IC.

Further, a timing control signal is supplied from the system controller 14 to the timing generator 16, and various timing signals are supplied from the timing generator 16 to the CMOS imaging device 12 to drive the CMOS imaging device 12.

Moreover, a wave detection signal of each signal component is taken in from the digital signal process unit 20 to the system controller 14. A gain of each color signal is controlled in the analog signal process unit 13 with the use of an AGC signal supplied from the system controller 14, and a signal process in the digital signal process unit 20 is controlled by the system controller 14.

Further, the camera-shake sensor 17 is coupled to the system controller 14. In a case where the object varies largely in a short time due to an operation of a person who shoots an image, that fact is detected by the system controller 14 on the basis of the output from the camera-shake sensor 17. The flicker-detection and correction unit 100 is thereby controlled, as will be described later.

Further, an operation unit 18a and a display unit 18b are coupled to the system controller 14 via an interface 19. The operation unit 18a and the display unit 18b configure the user interface 18. The interface 19 includes a microcomputer, etc. A setting operation, a selection operation, etc. performed on the operation unit 18a are thereby detected by the system controller 14, and a setting state of the camera, a control state of the camera, etc. are thereby displayed on the display unit 18b by the system controller 14.

### [Specific Example of Flicker-Detection and Correction Unit 100]

FIG. 8 illustrates one example of the flicker-detection and correction unit 100 of the imaging apparatus illustrated in FIG. 7.

The flicker-detection and correction unit 100 includes a normalized integral value calculating block 30, a DFT (discrete Fourier transform) block 51, a flicker generating block 53, and the computing block 40. Further, the flicker-detection and correction unit 100 includes an input image selecting unit 41, an estimation process unit 42, and a coefficient switching unit 43.

The normalized integral value calculating block 30 includes an integration block 31, an integral value holding block 32, an average value calculating block 33, a difference calculating block 34, and a normalizing block 35.

In the configuration illustrated in FIG. 8, the normalized integral value calculating block 30 and the DFT block 51 correspond to the flicker component detector 101 illustrated in FIG. 1. Further, the flicker generating block 53 corresponds to the correction coefficient calculator 102. Further, the estimation process unit 42 corresponds to the flicker component estimating unit 111 and the correction coefficient calculator 112. Further, the computing block 40 corresponds to the correction computing unit 103 and the correction computing unit 113.

### [Overview of Process of Flicker-Detection and Correction Unit 100]

First, the first image data group In1 is selected as an input image signal by the input image selecting unit 41, and the detection of the flicker component and the calculation process of the flicker coefficient Γn(y) are performed on the input image signal of the first image data group In1 by the input image selecting unit 41. Further, the estimation of the flicker component and the calculation process of the flicker coefficient Γn′(y) are performed on the second image data group In2 on the basis of a result of the detection of the flicker component performed on the input image signal of the first image data group In1.

In the coefficient switching unit 43, selective switching is performed between the flicker coefficient Γn(y) for the first image data group In1 and the flicker coefficient Γn′(y) for the second image data group In2, in accordance with the input timing of the first image data group In1 and the input timing of the second image data group In2, to perform output to the computing block 40. In the computing block 40, a computing process that reduces the flicker component is performed on the first image data group In1 on the basis of the flicker coefficient Γn(y), and a computing process that reduces the flicker component is performed on the second image data group In2 on the basis of the flicker coefficient Γn′(y).

[Detection of Flicker Component and Coefficient Calculation Process of Flicker Coefficient Γn(y) For First Image Data Group In1]

First, a description is given below of specific examples of detection of the flicker component and a calculation process of the flicker coefficient Γn(y) for the first image data group In1.

Hereinafter, each input image signal refers to an RGB primary color signal or a luminance signal before flicker reduction that is inputted to the flicker-detection and correction unit 100. Each output image signal refers to an RGB primary color signal or a luminance signal after the flicker reduction that is outputted from the flicker-detection and correction unit 100.

Further, a description is given below of an example of a case where an object is shot by a CMOS camera of an NTSC system (having a vertical synchronization frequency of 60 Hz) under illumination of a fluorescent lamp in a region having a commercial alternate-current power supply frequency of 50 Hz. In that case, as illustrated in FIGS. 14 to 16, variation in brightness and variation in color caused by flicker occurs not only between fields but also in a field. The variation in brightness and the variation in color appear as a stripe pattern for five periods (five wavelengths) in three fields (three screens) on the screen.

It is to be noted that, it goes without saying that the fluorescent lamp causes flicker in a case of a non-inverter type; however, the fluorescent lamp also causes flicker even in a case of an inverter type in a case where rectification is not sufficient. Therefore, the technology of the disclosure is not limited to the case where the fluorescent lamp is of the non-inverter type.

FIGS. 15 and 16 illustrate a case where the object is uniform, and the flicker component is generally proportional to signal intensity of the object.

Therefore, where the input image signal in any filed n and any pixel (x, y) for a general object is represented as In′(x, y), In′(x, y) is expressed by Expression (1) as a sum of a signal component not including the flicker component and a flicker component proportional thereto.

In′(x,y)=[1+Γn(y)]*In(x,y) (1)

where

$$\begin{matrix}Γ n ( y ) = {\sum }_{m = 1}^{∞} γ m * cos [ m * ( 2 π \text{/} λ o ) * y + Φ mn ] \\ = {\sum }_{m = 1}^{∞} γ m * cos ( m * ω o * y + Φ mn )\end{matrix} \qquad ( 2 )$$

In(x, y) is the signal component, Γn(y)*In(x, y) is the flicker component, and Γn(y) is the flicker coefficient. One horizontal period is sufficiently short compared with a light emission period ( 1/100 sec) of the fluorescent lamp, and it is possible to regard the flicker coefficient to be constant in the same line in the same field. Therefore, the flicker coefficient is expressed by Γn(y).

In order to generalize Γn(y), Γn(y) is described in a Fourier series expansion form, as expressed by Expression (2). This makes it possible to express the flicker coefficient in a form that covers all of the light emission characteristics and the afterglow characteristics that are different depending on the type of the fluorescent lamp.

λo in Expression (2) is a wavelength of in-screen flicker illustrated in FIG. 15, and corresponds to L (=M*60/100) lines where M is the number of reading lines per one field. ωo is a normalized angular frequency normalized by λo.

γm is an amplitude of the flicker component of each order (m=1, 2, 3 and so on). φmn is an initial phase of the flicker component of each order, and is determined by the light emission period ( 1/100 sec) of the fluorescent lamp and the exposure timing. It is to be noted that φmn takes the same value by each three fields. Therefore, a difference in φmn from that of a field immediately before is expressed by Expression (3).

Δφmn=(−2π/3)*m (3)

### [Calculation and Holding of Integral Value]

In the example illustrated in FIG. 8, first, the input image signal In′(x, y) is integrated for one line in the horizontal direction of the screen as expressed by Expression (4) in the integration block 31. The integration is performed in order to reduce an influence of a designed pattern for flicker detection. Thus, an integral value Γn(y) is calculated. αn(y) in Expression (4) is an integral value for one line of the signal component In(x, y), as expressed by Expression (5).

$$\begin{matrix}\begin{matrix}Fn ( y ) = {\sum }_{X} {In}^{′} ( x , y ) = {\sum }_{X} \{ [ 1 + Γ n ( y ) ] * In ( x , y ) \} \\ = {\sum }_{X} In ( x , y ) + Γ n ( y ) {\sum }_{X} In ( x , y ) \\ = α n ( y ) + α n ( y ) * Γ n ( y )\end{matrix} \\ where & ( 4 ) \\ α n ( y ) = {\sum }_{X} In ( x , y ) & ( 5 )\end{matrix}$$

The calculated integral value Γn(y) is stored and held in the integral value holding block 32 for the flicker detection in subsequent fields. The integral value holding block 32 has a configuration that is able to hold integral values for at least two fields.

If the object is uniform, the integral value αn(y) of the signal component In(x, y) becomes a constant value. Therefore, it is easy to extract the flicker component αn(y)*Γn(y) from the integral value Fn(y) of the input image signal In′(x, y).

However, in a case of a general object, the m*ωo component is also included in αn(y). Therefore, the luminance component and the color component as the flicker component are not separable from the luminance component and the color component as the signal component of the object itself. This prevents extraction of only pure flicker component. Further, the flicker component of the second term of Expression (4) is extremely small compared with the signal component of the first term of Expression (4). Therefore, the flicker component is almost buried in the signal component. For this reason, it can be said that it is impossible to directly extract the flicker component from the integral value Fn(y).

### [Average Value Calculation and Difference Calculation]

Accordingly, an integral value for three successive fields is used in order to exclude an influence of αn(y) from the integral value Fn(y) in the example illustrated in FIG. 8.

In other words, in this example, upon the calculation of the integral value Fn(y), an integral value Fn_1(y) of the same line in a field that is one field before and an integral value Fn_2(y) of the same line in a field that is two fields before are read from the integral value holding block 32. Further, an average value AVE[Fn(y)] of the three integral values Fn(y), Fn_1(y), and Fn_2(y) is calculated in the average value calculating block 33.

When it is possible to regard the object in a time period of three successive fields as almost the same, αn(y) is regarded as the same value. When the movement of the object is sufficiently small in the three fields, this assumption causes no practical problem. Further, to compute the average value of the integral values of the three successive fields is to sum signals having the phases of the flicker component sequentially shifted by (−2π/3)*m, as referring to the relationship in Expression (3). Therefore, the flicker component is canceled out as a result. Accordingly, the average value AVE [Fn(y)] is expressed by Expression (6).

$$\begin{matrix}AVE [ Fn ( y ) ] = ( 1 \text{/} 3 ) {\sum }_{k = 0}^{2} {Fn}_{—} k ( y ) \\ = ( 1 \text{/} 3 ) \{ {\sum }_{k = 0}^{2} α {n}_{—} k ( y ) + α {n}_{—} k ( y ) * Γ {n}_{—} k ( y ) \} \\ = ( 1 \text{/} 3 ) {\sum }_{k = 0}^{2} α {n}_{—} k ( y ) {\sum }_{k = 0}^{2} α {n}_{—} k ( y ) * Γ {n}_{—} k ( y ) \\ = α n ( y ) + ( 1 \text{/} 3 ) * α n ( y ) {\sum }_{k = 0}^{2} Γ {n}_{—} k ( y ) \\ = α n ( y )\end{matrix} \qquad ( 6 )$$

where

αn(y)≅αn_1(y)≅αn_2(y) (7)

It is to be noted that the description above is applicable to a case where the average value of the integral values in three successive fields is calculated on the assumption that the approximation expressed by Expression (7) is satisfied. However, the approximation expressed by Expression (7) is not satisfied in a case where the movement of the object is large.

Therefore, in a case where a case in which the movement of the object is large is expected, the following calculation should be performed. That is, the integral values for three or more fields are held in the integral value holding block 32, and the average value of the integral values for four or more fields including the integral value Fn(y) of the present field is calculated. This reduces an influence of the movement of the object, by a low-pass filter function in a temporal-axis direction.

However, the flicker occurs repeatedly by each three fields. Therefore, it is necessary to calculate the average value of the integral values in j-number of successive fields (where “j” is an integer multiple of “3” and is greater than a double of “3”, that is, 6, 9, and so on), in order to cancel out the flicker component. Therefore, the integral value holding block 32 has a configuration that is able to hold the integral values for at least (j−1) fields.

The example illustrated in FIG. 8 is a case on the assumption that the approximation of Expression (7) is satisfied. In this example, further, a difference between the integral value Fn(y) of the current field obtained from the integration block 31 and the integral value Fn_1(y) of the field that is one field before and is obtained from the integral value holding block 32 is calculated in the difference calculating block 34 to obtain a difference value Fn(y)−Fn_1(y) expressed by Expression (8). Expression (8) is provided also on the assumption that the approximation of Expression (7) is satisfied.

$$\begin{matrix}Fn ( y ) - {Fn}_{—} 1 ( y ) = & \{ α n ( y ) + α n ( y ) * Γ n ( y ) \} - \\ & \{ α {n}_{—} 1 ( y ) + α {n}_{—} 1 ( y ) * Γ {n}_{—} 1 ( y ) \} \\ = & α n ( y ) * \{ Γ n ( y ) - Γ {n}_{—} 1 ( y ) \} \\ = & α n ( y ) {\sum }_{m = 1}^{∞} γ m * \{ cos ( m * ω o * y + Φ mn ) - \\ & cos ( m * ω o * y + Φ {mn}_{—} 1 ) \}\end{matrix} \qquad ( 8 )$$

The influence of the object is sufficiently excluded from the difference value Fn(y)−Fn_1(y) of the three successive fields. Therefore, a state of the flicker component (the flicker coefficient) appears more clearly in the difference value Fn(y)−Fn_1(y) of the three successive fields than in the integral value Fn(y).

### [Normalization of Difference Value]

In the example illustrated in FIG. 8, further, the difference value Fn(y)−Fn_1(y) obtained from the difference calculating block 34 is divided in the normalizing block 35 by the average value AVE[Fn(y)] obtained from the average value calculating block 33, to be thereby normalized. Thus, a difference value gn(y) after the normalization is calculated.

The difference value gn(y) after the normalization is expanded as Expression (9) on the basis of Expressions (6) and (8) and trigonometric sum identities.

$$\begin{matrix}gn ( y ) = & \{ Fn ( y ) - {Fn}_{—} 1 \} \text{/} AVE [ Fn ( y ) ] \\ = & {\sum }_{m = 1}^{∞} γ m * \{ cos ( m * ω o * y + Φ mn ) - \\ & cos ( m * ω o * y + Φ {mn}_{—} 1 ) \} \\ = & {\sum }_{m = 1}^{∞} ( - 2 ) γ m \{ sin [ m * ω o * y + ( Φ mn + Φ {mn}_{—} 1 ) \text{/} 2 ] * \\ & sin [ ( Φ mn - Φ {mn}_{—} 1 ) \text{/} 2 ] \}\end{matrix} \qquad ( 9 )$$

Further, the difference value gn(y) after the normalization is further expressed by Expression (10) on the basis of the relationship expressed by Expression (3). |Am| and θm in Expression (10) are expressed by Expressions (11a) and (11b), respectively.

$$\begin{matrix}gn ( y ) = & {\sum }_{m = 1}^{∞} ( - 2 ) γ m * sin ( m * ω o * y + Φ mn + m * π \text{/} 3 ) * \\ & sin ( - m * π \text{/} 3 ) \\ = & {\sum }_{m = 1}^{∞} 2 * γ m * cos ( m * ω o * y + Φ mn + m * π \text{/} 3 - π \text{/} 2 ) * \\ & sin ( m * π \text{/} 3 ) \\ = & {\sum }_{m = 1}^{∞} 2 * γ m * sin ( m * π \text{/} 3 ) * \\ & cos ( m * ω o * y - Φ mn + m * π \text{/} 3 - π \text{/} 2 ) \\ = & {\sum }_{m = 1}^{∞} \vert Am \vert * cos ( m * ω o * y + θ m )\end{matrix} \qquad ( 10 )$$

where

|Am|=2*γm*sin(m*π/3) (11a)

θm=Φmn+m*π/3−π/2 (11b)

The influence of the signal intensity of the object remains in the difference value Fn(y)−Fn_1(y). Therefore, the levels of the variation in luminance and the variation in color both due to the flicker are different between regions. However, it is possible to allow the variation in luminance and the variation in color both due to the flicker to be at the same level over all regions by the normalization.

### [Estimation of Flicker Component by Spectrum Extraction]

|Am| and θm expressed by Expressions (11a) and (11b), respectively, are the amplitude and the initial phase of the spectrum of each order of the difference value gn(y) after the normalization. When the difference value gn(y) after the normalization is subjected to Fourier transform to detect the amplitude |Am| and the initial phase θm of the spectrum of each order, it is possible to obtain, by Expressions (12a) and (12b), the amplitude γm and the initial phase φmn of the flicker component of each order expressed by Expression (2).

γm=|Am|/[2*sin(m*π/3)] (12a)

Φmn=θm−m*π/3−π/2 (12b)

Therefore, in the example illustrated in FIG. 8, the data, of the difference value gn(y) after the normalization obtained from the normalizing block 35, that corresponds to one wavelength (the L line) of the flicker is subjected to discrete Fourier transform in the DFT block 51.

DFT computing is expressed by Expression (13), where DFT[gn(y)] is the DFT computing and Gn(m) is a result of DFT of m-order. W in Expression (13) is expressed by Expression (14).

$$DFT [ gn ( y ) ] = Gn ( m ) = {\sum }_{i = 0}^{L - 1} gn ( i ) * {W}^{m * i} \qquad ( 13 )$$

where

W=exp[−j*2π/L] (14)

Further, the relationship between Expressions (11a) and (11b) and Expression (13) is expressed by Expressions (15a) and (15b) on the basis of the definition of DFT.

|Am|=2*|Gn(m)|/L (15a)

θm=tan⁻¹{Im[Gn(m)]/Re[Gn(m)]} (15b)

where

Im[Gn(m)]: imaginary part

Re[Gn(m)]: real part

Accordingly, it is possible to obtain, by Expressions (16a) and (16b), the amplitude γm and the initial phase φmn of the flicker component of each order, from Expressions (12a), (12b), (15a), and (15b).

γm=|Gn(m)|/[L*sin(m*η/3)] (16a)

Φmn=tan⁻¹{Im[Gn(m)]/Re[Gn(m)]}−m*π/3+π/2 (16b)

A reason why the data length of the DFT computing is set as one wavelength (the L line) of the flicker is that it is thereby possible to directly obtain the discrete spectrum group of exactly the integer-multiple of ωo.

In general, FFT (fast Fourier transform) is used as the Fourier transform in a digital signal process. In the present embodiment of the invention, however, DFT is used by intention. A reason therefor is that it is convenient to use DFT than to use FFT as the data length of Fourier transform is not power of 2. However, it is possible to use FFT by processing input-output data.

The approximation of the flicker component is sufficiently possible under the illumination of the actual fluorescent lamp even when the order number “m” is limited to the number such as two or three. Therefore, it is not necessary to output all of the data for DFT computing. Accordingly, there is no disadvantage in terms of computing efficiency in this application of the invention, compared with FFT.

In the DFT block 51, the spectrum is extracted first by the DFT computing defined by Expression (13), and thereafter, the amplitude γm and the initial phase φmn of the flicker component of each order are estimated by the computing using Expressions (16a) and (16b).

In the example illustrated in FIG. 8, further, the flicker coefficient Γn(y) expressed by Expression (2) is calculated in the flicker generating block 53 from the estimated values of γm and φmn obtained from the DFT block 51.

It is to be noted that the approximation of the flicker component is sufficiently possible under the illumination of the actual fluorescent lamp even when the order number “m” is limited to the number such as two or three, as described above. Therefore, it is possible to limit the sum order to the predetermined order, for example, to second order, instead of setting the sum order to infinite, upon the calculation of the flicker coefficient Γn(y) based on Expression (2).

According to the method described above, it is possible to detect the flicker component with high accuracy by calculating the difference value Fn(y)−Fn_1(y) even in a region in which the flicker component is to be completely buried in the signal component in the integral value Fn(y), and normalizing the calculated value by the average value AVE[Fn(y)]. The region in which the flicker component is to be completely buried in the signal component in the integral value Fn(y) is, for example, a black background part having extremely small flicker component, or a part having low illuminance.

Moreover, to estimate the flicker component from the spectrum of up to appropriate order is to perform approximation without completely reproducing the difference value gn(y) after the normalization. However, this conversely makes it possible to estimate, with high accuracy, the flicker component of a discontinuous part of the difference value gn(y) after the normalization even when such discontinuous part is caused due to the condition of the object.

### [Calculation Directed to Flicker Reduction]

From Expression (1), the signal component In(x, y) not including the flicker component is expressed by Expression (17).

In(x,y)=In′(x,y)/[1+Γn(y)] (17)

Accordingly, in the computing block 40, “1” is added to the flicker coefficient Γn(y) obtained from the flicker generating block 53, and the input image signal In′(x, y) is divided by the calculated sum [1+Γn(y)], in the example illustrated in FIG. 8.

Regarding the first image data group In1, the flicker component included in the input image signal In′ (x, y) is almost completely excluded thereby. Therefore, the signal component In (x, y) substantially including no flicker component is obtained from the computing block 40 as the output image signal (the RGB primary color signal or the luminance signal after the flicker reduction).

It is to be noted that, in a case where not all of the above-described processes are completed in time corresponding to one filed because of limitation of computing performance of the system, the computing block 40 should be configured to have a function that holds the flicker coefficient Γn(y) for three fields by utilizing the fact that the flicker occurs repeatedly by each three fields. The flicker coefficient Γn(y) thus held is subjected to computing for the input image signal In′(x, y) of the field three fields after.

[Estimation of Flicker Component and Coefficient Calculation Process of Flicker Coefficient Γn′(y) for Second Image Data Group In2]

Next, a description is given of a specific example of estimation of the flicker component for the second image data group In2 and the calculation process of the flicker coefficient Γn′(y).

In the computing block 40, a process similar to the process for the first image data group In1 is performed on the second image data group In2 by the use of the flicker coefficient Γn′(y). In other words, in the computing block 40, 1 is added to the flicker coefficient Γ′n(y) obtained from the estimation process unit 42, and the input image signal In′(x, y) for the second image data group In2 is divided by the calculated sum [1+Γn′(y)].

Accordingly, regarding the second image data group In2, the flicker component included in the input image signal In′ (x, y) is almost completely excluded. Therefore, the signal component In (x, y) substantially including no flicker component is obtained from the computing block 40 as the output image signal.

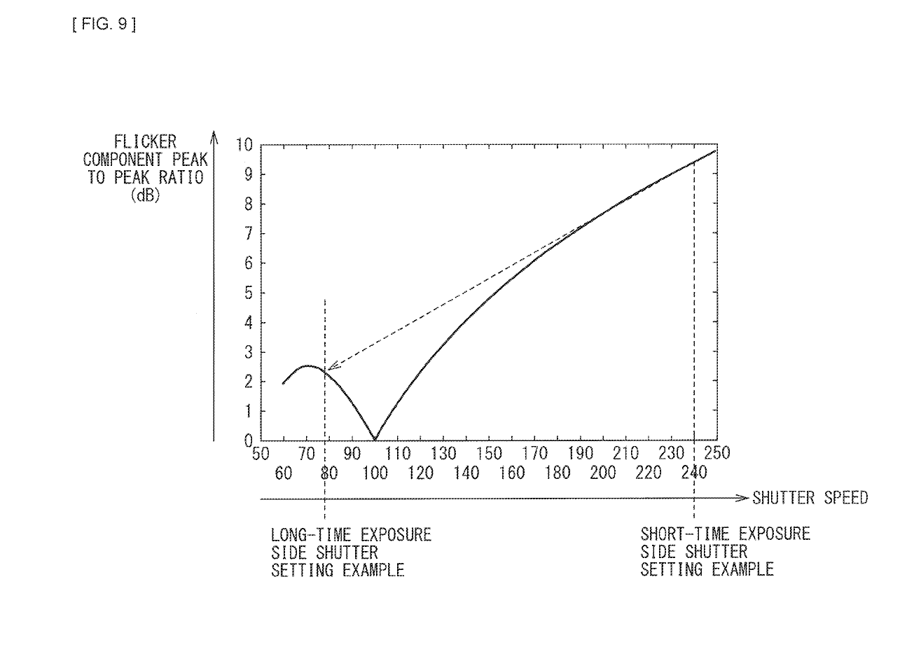

FIG. 9 illustrates one example of a method of calculating an amplitude ratio of flicker component of long-time exposure from an amplitude ratio of flicker component of short-time exposure. In a case where the data group of the short-time exposure image S is set as the first image data group In1 and the data group of the long-time exposure image L is set as the second image data group In2, for example, it is possible to estimate the amplitude ratio of flicker component of the long-time exposure from the amplitude ratio of flicker component of the short-time exposure, as illustrated in FIG. 9.

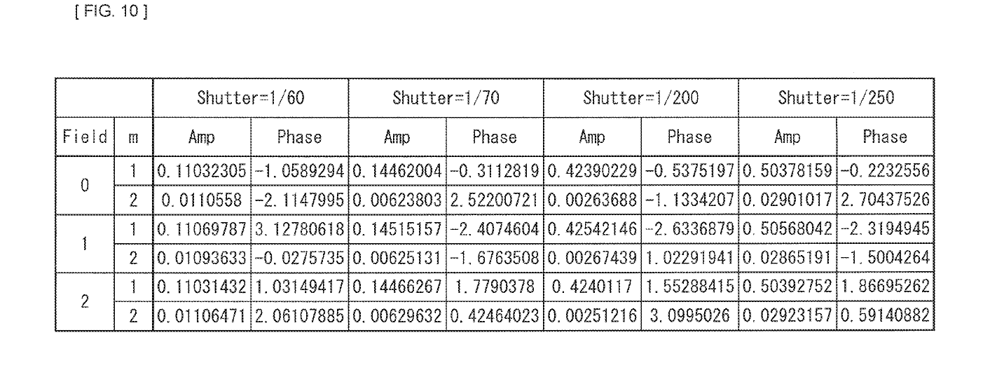

FIG. 10 illustrates a data example of a reference table used in estimation of the flicker component. FIG. 10 illustrates a data example for three successive fields (Field0, 1, and 2). In FIG. 10, “m” is the order of the Fourier series described above. FIG. 10 includes data of the amplitude (Amp) and the initial phase (Phase) of the flicker component for each flied and each order in respective cases where the exposure times are 1/60, 1/70, 1/200, and 1/250.

The estimation process unit 42 is able to estimate the amplitude γm and the initial phase φm of the flicker component for the second image data group In2, for example, by storing the data of the reference table such as that illustrated in FIG. 10 in advance.

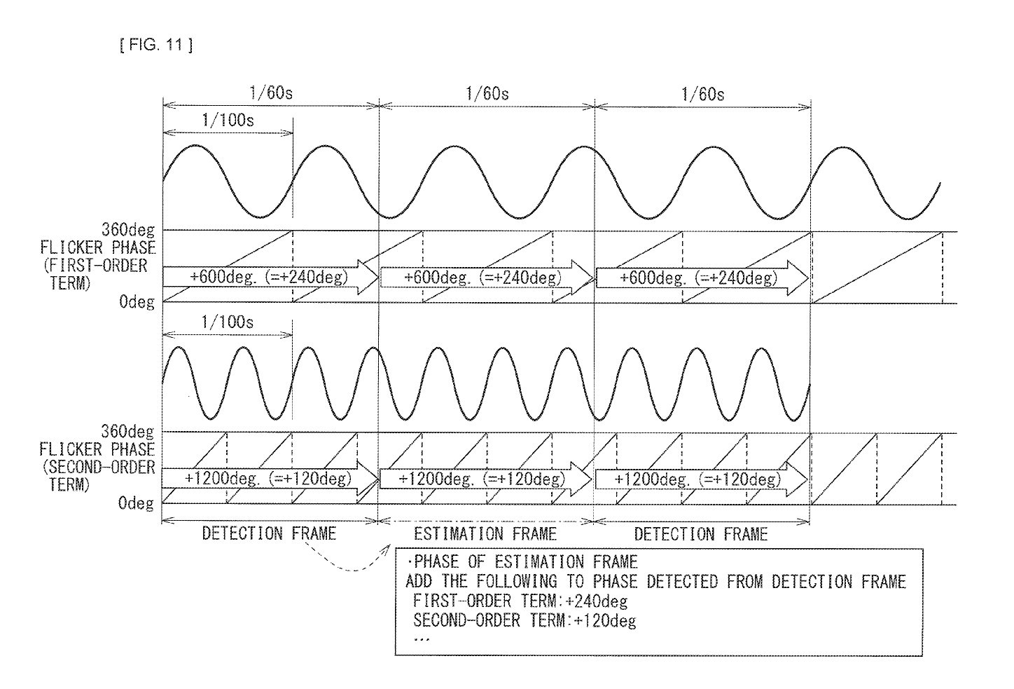

FIG. 11 illustrates one example of a method of calculating a phase of the flicker component. FIG. 11 illustrates an example in which the commercial alternate-current power supply frequency is 50 Hz, the vertical synchronization frequency is 60 Hz, and the one field period is 1/60 sec. Further, FIG. 11 illustrates an example of a case where the data of the short-time exposure image S as a detection frame and the data of the long-time exposure image L as an estimation frame are inputted alternately. An upper part of FIG. 11 illustrates a waveform of the flicker component of the term of m=1st order. A lower part of FIG. 11 illustrates a waveform of the flicker component of the term of m=2nd order.

In the estimation process unit 42, it is possible to estimate the initial phase of the flicker component in the second image data group In2 on the basis of a difference in exposure start timing between the first image data group In1 and the second image data group In2. For example, it is possible, regarding the first-order term, to calculate the initial phase of the estimation frame by adding+240 dg with respect to the initial phase detected in the detection frame, in the example illustrated in FIG. 11. Further, it is possible, regarding the second-order term, to calculate the initial phase of the estimation frame by adding+120 dg with respect to the initial phase detected in the detection frame.

### [1.3 Effects]

According to the present embodiment, the flicker component in the first image data is detected on the basis of the plurality of pieces of first image data having short exposure time, in the plurality of pieces of image data that are different from each other in exposure time, as described above. It is therefore possible to easily detect the flicker component included in the plurality of pieces of image data that are different from each other in exposure time. This makes it possible to achieve a high-quality HDR moving image by a simple, low-cost, and low-power-consumption system configuration, even under an environment in which fluorescent lamp flicker occurs. It is also possible, in a case where the number of pieces of image data to be used in generation of the HDR synthesized image is increased, to achieve a system that is compatible to such a case in a scalable manner.

It is to be noted that the effects described in the present description are mere examples and non-limiting. Further, any other effect may be provided. This is similarly applicable to effects of other embodiments described below.

### 2. Second Embodiment

Next, a second embodiment of the disclosure is described. Hereinafter, a description of a part that has a configuration and a working substantially similar to those in the first embodiment described above will be omitted where appropriate.

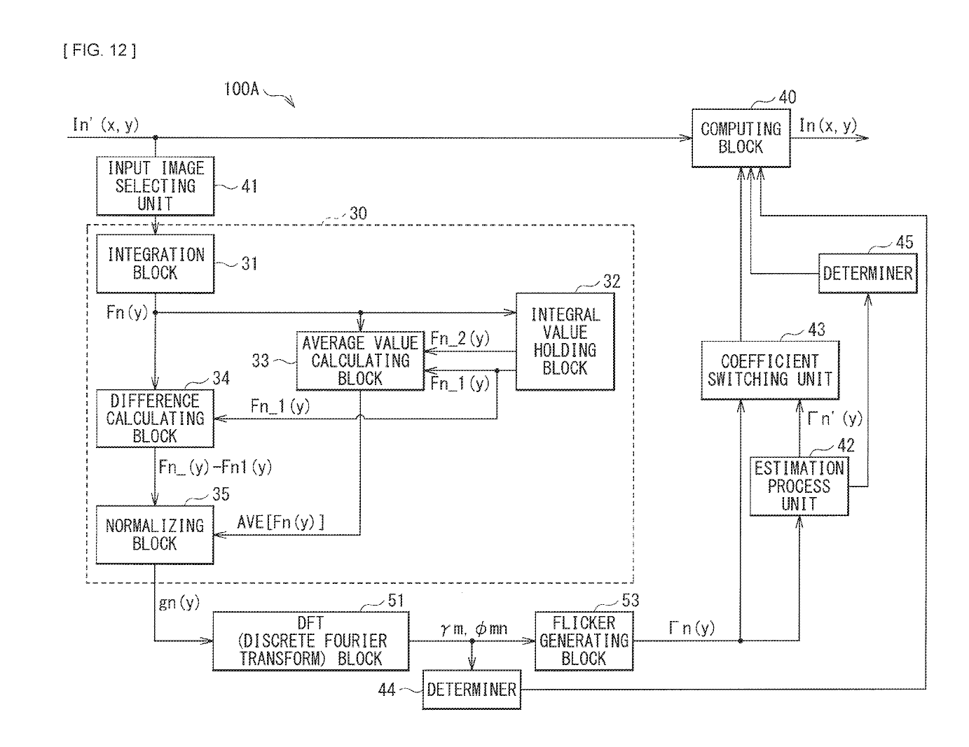

FIG. 12 illustrates one example of a flicker-detection and correction unit 100A according to the second embodiment of the disclosure.

The configuration example illustrated in FIG. 12 is additionally provided with a determiner 44 and a determiner 45 compared with the configuration of the flicker-detection and correction unit 100 illustrated in FIG. 8.

The determiner 44 is a first determiner that determines, on the basis of a result of the detection of the flicker component, whether or not to perform, on the image data of the first image data group In1, a process that reduces the flicker component. The computing block 40 performs, on the image data of the first image data group In1, the process that reduces the flicker component, in accordance with a result of the determination performed by the determiner 44.

This makes it possible to perform the correction process on the image data of the first image data group In1 on an as-needed basis, while the process of detecting the flicker component is constantly performed on the image data of the first image data group In1. For example, it is possible to perform the correction process only in a case where the amplitude of the flicker component of the first image data group In1 is large or in a case where the phase of the flicker component of the first image data group In1 is varied periodically.

The determiner 45 is a second determiner that determines, on the basis of a result of the estimation performed by the estimation process unit 42, whether or not to perform, on the image data of the second image data group In2, a process that reduces the flicker component. The computing block 40 performs, on the image data of the second image data group In2, the process that reduces the flicker component, in accordance with a result of the determination performed by the determiner 45.

This makes it possible to perform the correction process on the image data of the second image data group In2 on an as-needed basis, while the process of estimating the flicker component is constantly performed on the image data of the second image data group In2. For example, it is possible to perform the correction process only in a case where the amplitude of the flicker component of the second image data group In2 is large or in a case where the phase of the flicker component of the second image data group In2 is varied periodically.

A configuration, an operation, and an effect other than those described above may be substantially similar to those of the first embodiment described above.

### 3. Other Embodiments

The technology of the disclosure is not limited to the above description of each embodiment, and is modifiable in variety of ways.

For example, the respective embodiments described above refer to an example in which the stream inputted to the image processor includes the data of the short-time exposure image S and the data of the long-time exposure image L, as illustrated in FIG. 4. However, data of other exposure image may be further included. For example, as illustrated in FIG. 20, data of intermediate exposure image M may be further included as image data having third exposure time, and a stream including the data of the short-time exposure image S, the data of the intermediate exposure image M, and the data of the long-time exposure image L that are provided in a temporally-alternate arrangement may be inputted to the image processor. Further, for example, the first image data group In1 may be configured of the data of the short-time exposure image S, the second image data group In2 may be configured of the data of the long-time exposure image L, and a third image data group In3 may be configured of the data of the intermediate exposure image M. Further, the pieces of data of different exposure image are not limited to three types, and may be four or more types.

As described above, the technology of the disclosure may be applied to at least two types of pieces of data of different exposure images, in a case of the stream including three or more types of pieces of data of different exposure images. For example, the technology of the disclosure may be applied to, at least, the data of the short-time exposure image S and the data of the long-time exposure image L in the example illustrated in FIG. 20. The disclosure is a technology that is applied to the stream provided with a temporally-alternate arrangement of the first image data and the second image data. “Alternate” in this case also encompasses a case where other image data is arranged between the first image data and the second image data. For example, such a case is the case in which the technology of the disclosure is applied to the data of the short-time exposure image S and the data of the long-time exposure image L in the example illustrated in FIG. 20. For example, even when the intermediate exposure image M as other image data is provided besides the data of the short-time exposure image S and the data of the long-time exposure image L in the example illustrated in FIG. 20, the technology of the disclosure is applicable as seeing the example as a case in which the data of the short-time exposure image S and the data of the long-time exposure image L are provided in an alternate arrangement.

Moreover, the respective embodiments above are provided with a description referring to an example of a case where the exposure time of a single piece of image data is one filed ( 1/60 sec) at the longest. However, the technology of the disclosure is also applicable to a case where the single piece of image data is one frame ( 1/30 second) at the longest. For example, the single piece of image data may be data that is 1/30 sec at the longest that is shot by a progressive camera having the vertical synchronization frequency of 30 Hz and one frame period of 1/30 sec.

Moreover, the respective embodiments above have been described referring, as an example, to the flicker that occurs under illumination of the non-inverter fluorescent lamp having the period of variation in luminance of 1/100 sec when the commercial alternate-current power supply frequency is 50 Hz. However, the technology of the disclosure is also applicable to illumination that causes flicker having a period different from that of the fluorescent lamp described above. For example, the technology of the disclosure is also applicable to flicker caused by LED (Light Emitting Diode) illumination, etc.

Moreover, the technology of the disclosure is also applicable to a vehicle-mounted camera, a monitoring camera, etc.

Moreover, it is possible for the technology to have the foregoing configurations, for example.

(1)

An image processor including a detector that detects a flicker component in first image data on the basis of a plurality of pieces of first image data in a stream, the stream including, at least, the plurality of pieces of first image data having first exposure time and a plurality of pieces of second image data having second exposure time, the stream being provided with a temporally-alternate arrangement of the first image data and the second image data, the second exposure time being different from the first exposure time.

(2)

The image processor according to (1), in which the first exposure time is shorter than the second exposure time.

(3)

The image processor according to (1) or (2), in which the stream further includes a plurality of pieces of third image data having third exposure time, the third exposure time being different from both the first exposure time and the second exposure time, and the first image data, the second image data, and the third image data are provided in a temporally-alternate arrangement.

(4)

The image processor according to any one of (1) to (3), in which the first image data is image data that has shortest exposure time in pieces of image data included in the stream.

(5)

The image processor according to any one of (1) to (4), further including an estimating unit that estimates a flicker component in the second image data on the basis of a result of the detection performed by the detector.

(6)

The image processor according to any one of (1) to (5), further including a first computing unit that performs, on the first image data, a process that reduces the flicker component, on the basis of a result of the detection performed by the detector.

(7)

The image processor according to (5), further including a second computing unit that performs, on the second image data, a process that reduces the flicker component, on the basis of a result of the estimation performed by the estimating unit.

(8)

The image processor according to (5) or (7), in which the estimating unit estimates an amplitude of the flicker component in the second image data, on the basis of a difference in exposure time between the first image data and the second image data.

(9)

The image processor according to (5), (7), or (8), in which the estimating unit estimates an initial phase of the flicker component in the second image data, on the basis of a difference in exposure start timing between the first image data and the second image data.

(10)

The image processor according to (6), further including

a first determiner that determines, on the basis of the result of the detection performed by the detector, whether or not to perform, on the first image data, the process that reduces the flicker component, in which

the first computing unit performs, in accordance with a result of the determination performed by the first determiner, the process that reduces the flicker component.

(11)

The image processor according to (7), further including

a second determiner that determines, on the basis of the result of the estimation performed by the estimating unit, whether or not to perform, on the second image data, the process that reduces the flicker component, in which

the second computing unit performs, in accordance with a result of the determination performed by the second determiner, the process that reduces the flicker component.

(12)

The image processor according to (5), further including:

a first computing unit that performs, on the first image data, a process that reduces the flicker component, on the basis of the result of the detection performed by the detector;

a second computing unit that performs, on the second image data, a process that reduces the flicker component, on the basis of a result of the estimation performed by the estimating unit; and

an image synthesizing unit that performs synthesis of the first image data on which the process that reduces the flicker component has been performed by the first computing unit and the second image data on which the process that reduces the flicker component has been performed by the second computing unit.

(13)

The image processor according to (12), in which the image synthesizing unit performs an image synthesis process that increases a dynamic range.

(14)

An image processing method including detecting a flicker component in first image data on the basis of a plurality of pieces of first image data in a stream, the stream including, at least, the plurality of pieces of first image data having first exposure time and a plurality of pieces of second image data having second exposure time, the stream being provided with a temporally-alternate arrangement of the first image data and the second image data, the second exposure time being different from the first exposure time.

(15)

A program that causes a computer to function as a detector that detects a flicker component in first image data on the basis of a plurality of pieces of first image data in a stream, the stream including, at least, the plurality of pieces of first image data having first exposure time and a plurality of pieces of second image data having second exposure time, the stream being provided with a temporally-alternate arrangement of the first image data and the second image data, the second exposure time being different from the first exposure time.

This application claims the priority on the basis of Japanese Patent Application No. 2015-228789 filed on Nov. 24, 2015 with Japan Patent Office, the entire contents of which are incorporated in this application by reference.

Those skilled in the art could assume various modifications, combinations, subcombinations, and changes in accordance with design requirements and other contributing factors. However, it is understood that they are included within a scope of the attached claims or the equivalents thereof.

1. An image processor comprising a detector that detects a flicker component in first image data on a basis of a plurality of pieces of first image data in a stream, the stream including, at least, the plurality of pieces of first image data having first exposure time and a plurality of pieces of second image data having second exposure time, the stream being provided with a temporally-alternate arrangement of the first image data and the second image data, the second exposure time being different from the first exposure time.

2. The image processor according to claim 1, wherein the first exposure time is shorter than the second exposure time.

3. The image processor according to claim 1, wherein the stream further includes a plurality of pieces of third image data having third exposure time, the third exposure time being different from both the first exposure time and the second exposure time, and the first image data, the second image data, and the third image data are provided in a temporally-alternate arrangement.

4. The image processor according to claim 1, wherein the first image data is image data that has shortest exposure time in pieces of image data included in the stream.

5. The image processor according to claim 1, further comprising an estimating unit that estimates a flicker component in the second image data on a basis of a result of the detection performed by the detector.

6. The image processor according to claim 1, further comprising a first computing unit that performs, on the first image data, a process that reduces the flicker component, on a basis of a result of the detection performed by the detector.

7. The image processor according to claim 5, further comprising a second computing unit that performs, on the second image data, a process that reduces the flicker component, on a basis of a result of the estimation performed by the estimating unit.

8. The image processor according to claim 5, wherein the estimating unit estimates an amplitude of the flicker component in the second image data, on a basis of a difference in exposure time between the first image data and the second image data.

9. The image processor according to claim 5, wherein the estimating unit estimates an initial phase of the flicker component in the second image data, on a basis of a difference in exposure start timing between the first image data and the second image data.

10. The image processor according to claim 6, further comprising
a first determiner that determines, on the basis of the result of the detection performed by the detector, whether or not to perform, on the first image data, the process that reduces the flicker component, wherein
the first computing unit performs, in accordance with a result of the determination performed by the first determiner, the process that reduces the flicker component.

11. The image processor according to claim 7, further comprising
a second determiner that determines, on the basis of the result of the estimation performed by the estimating unit, whether or not to perform, on the second image data, the process that reduces the flicker component, wherein
the second computing unit performs, in accordance with a result of the determination performed by the second determiner, the process that reduces the flicker component.

12. The image processor according to claim 5, further comprising:
a first computing unit that performs, on the first image data, a process that reduces the flicker component, on the basis of the result of the detection performed by the detector;
a second computing unit that performs, on the second image data, a process that reduces the flicker component, on a basis of a result of the estimation performed by the estimating unit; and
an image synthesizing unit that performs synthesis of the first image data on which the process that reduces the flicker component has been performed by the first computing unit and the second image data on which the process that reduces the flicker component has been performed by the second computing unit.

13. The image processor according to claim 12, wherein the image synthesizing unit performs an image synthesis process that increases a dynamic range.

14. An image processing method comprising detecting a flicker component in first image data on a basis of a plurality of pieces of first image data in a stream, the stream including, at least, the plurality of pieces of first image data having first exposure time and a plurality of pieces of second image data having second exposure time, the stream being provided with a temporally-alternate arrangement of the first image data and the second image data, the second exposure time being different from the first exposure time.

15. A program that causes a computer to function as a detector that detects a flicker component in first image data on a basis of a plurality of pieces of first image data in a stream, the stream including, at least, the plurality of pieces of first image data having first exposure time and a plurality of pieces of second image data having second exposure time, the stream being provided with a temporally-alternate arrangement of the first image data and the second image data, the second exposure time being different from the first exposure time.
